(19) United States
(12) Patent Application Publication
(10) Pub. No.: US 2012/0328850 A1
(43) Pub. Date: Dec. 27, 2012

(54) Sheet Materials Having Improved Softness

(76) Inventors: Ali Yahiaoui, Roswell, GA (US); Ann McCormack, Dahlonega, GA (US); Simon Poruthoor, Alpharetta, GA (US)

(21) Appl. No.: 13/169,633

(22) Filed: Jun. 27, 2011

(51) Int. Cl. B32B 5/00

(52) U.S. Cl. 428/195.1

(57) ABSTRACT

As disclosed herein, an article defining a visible surface includes a sheet material, an ink composition overlaying the sheet material, and a softening agent overlaying the ink composition, wherein the ink composition is positioned between the sheet material and the softening agent. For example, the softening agent may be selected from the group consisting of erucamide, cetyl 2-ethylhexanone, ethylhexyl stearate, ethylhexyl hydroxyetarate, perfluorinated dimethicone, and so forth. The articles have reduced static coefficient of friction and maintain oil Crockfastness.

### BACKGROUND OF THE INVENTION

Absorbent articles typically include an outercover constructed from a substrate laminate of a liquid impermeable film and a nonwoven fabric constructed from hydrophobic polymeric fibers. These outercovers may be printed with graphics that enhance the aesthetic appeal of the absorbent article. Durability of the printed graphics is important to reduce the chance that the graphic may rub off of the outercover onto, for example, the skin of the wearer or the caretaker, or any other item the outercover may contact. It has been found, though, that the process of printing graphics on the substrate may negatively impact the soft feel of the substrate.

Accordingly, there is a need to improve the softness of printed substrates. Additionally, there exists a need to improve the softness of printed substrates without negatively impacting the durability of an ink composition applied to the nonwoven surface of a film-web laminate, such as those useful as an outercover of an absorbent article.

### SUMMARY OF THE INVENTION

Objects and advantages of the invention will be set forth in part in the following description, or may be obvious from the description, or may be learned through practice of the invention.

In one embodiment, an article defining a visible surface includes a sheet material, an ink composition overlaying the sheet material, and a softening agent overlaying the ink composition, wherein the ink composition is positioned between the sheet material and the softening agent. For example, the softening agent may be selected from the group consisting of erucamide, cetyl 2-ethylhexanone, ethylhexyl stearate, ethylhexyl hydroxyetarate, perfluorinated dimethicone, and so forth. The basis weight of the softening agent on the sheet material may be from about 0.1 to about 6 grams per square meter, optionally from about 0.1 to about 4 grams per square meter. The basis weight of the ink composition may be from about 0.01 to about 10 grams per square meter, optionally from about 0.01 to about 2 grams per square meter. The basis weight of the sheet material may be from about 6 to about 50 grams per square meter.

In one aspect, the sheet material may include synthetic polymer fibers interlaid to form a nonwoven web. As one example, the nonwoven web may include polyolefin fibers.

In a further aspect, the ink composition may include a crosslinking agent in an amount greater than about 3.5% by weight based on the dried weight of the ink composition, wherein the crosslinking agent includes an aziridine oligomer with at least two aziridine functional groups. The ink composition may further include an acrylic colloidal dispersion polymer.

In an even further aspect, the nonwoven web may be laminated to a breathable film comprising micropores such that the visible surface of the nonwoven web is opposite of the breathable film.

In another embodiment, an absorbent article may include a liquid permeable topsheet, an absorbent core, and a liquid impermeable backsheet, wherein the absorbent core is positioned between the topsheet and the backsheet. The backsheet may include a nonwoven web overlying a film layer such that the film layer faces the absorbent core and the nonwoven web defines a visible surface that includes synthetic polymer fibers interlaid to form a nonwoven web, an ink composition overlaying the synthetic polymer fibers of the nonwoven web, and, a softening agent overlying the ink composition, wherein the ink composition is positioned between the synthetic polymer fibers and the softening agent. The softening agent may be selected from the group consisting of erucamide, cetyl 2-ethyl hexanone, ethylhexyl stearate, ethylhexyl hydroxyetarate, perfluorinated dimethicone, and so forth. The basis weight of the softening agent may be from about 0.1 to about 6 grams per square meter, optionally from about 0.1 to about 4 grams per square meter.

In a further embodiment, a method of providing a soft, printed nonwoven web includes the steps of providing a nonwoven web of synthetic fibers, wherein the nonwoven web has a visible surface, applying an ink composition to the visible surface of the nonwoven web to form a printed surface, and applying a softening agent to the printed surface. The softening agent may be selected from the group consisting of erucamide, cetyl 2-ethylhexanone, ethylhexyl stearate, ethylhexyl hydroxyetarate, perfluorinated dimethicone, and so forth. The softening agent may be, for example, flexographically printed or ink jet printed on the nonwoven web. In some aspects the softening agent may be slot coated on to the nonwoven web, solvent spray coated on to the nonwoven web, thermal spray coated on to the nonwoven web, meltblown on to the nonwoven web, placed in controlled or patterned areas on the nonwoven web, or applied to the nonwoven web as a monolithic film or particulates.

In other aspects, the ink composition may include a crosslinking agent in an amount of greater than about 1.0% by weight, optionally greater than about 3.5% by weight, based on the dried weight of the ink composition, wherein the crosslinking agent comprises an aziridine oligomer with at least two aziridine functional groups, and further wherein the method further comprises the step of crosslinking the ink composition after applying the softening agent.

Other features and aspects of the present invention are discussed in greater detail below.

### BRIEF DESCRIPTION OF THE FIGURES

A full and enabling disclosure of the present invention, including the best mode thereof to one skilled in the art, is set forth more particularly in the remainder of the specification, which includes reference to the accompanying figures, in which:

FIG. 1 is a perspective view of an exemplary training pant 10; and

FIG. 2 is an exploded cross-sectional view of FIG. 1 taken along line 2-2.

FIGS. 3 a-c are cross-sectional views of different embodiments of sheet materials of the present invention.

Repeat use of reference characters in the present specification and drawings is intended to represent the same or analogous features or elements of the present invention.

### DETAILED DESCRIPTION OF REPRESENTATIVE EMBODIMENTS

### Definitions

As used herein the term “nonwoven fabric or web” refers to a web having a structure of individual fibers or threads which are interlaid, but not in an identifiable manner as in a knitted fabric. Nonwoven fabrics or webs have been formed from many processes such as for example, meltblowing processes, spunbonding processes, bonded carded web processes, etc.

As used herein, the term “meltblown web” generally refers to a nonwoven web that is formed by a process in which a molten thermoplastic material is extruded through a plurality of fine, usually circular, die capillaries as molten fibers into converging high velocity gas (e.g. air) streams that attenuate the fibers of molten thermoplastic material to reduce their diameter, which may be to microfiber diameter. Thereafter, the meltblown fibers are carried by the high velocity gas stream and are deposited on a collecting surface to form a web of randomly disbursed meltblown fibers. Such a process is disclosed, for example, in U.S. Pat. No. 3,849,241 to Butin, et al., which is incorporated herein in its entirety by reference thereto for all purposes. Generally speaking, meltblown fibers may be microfibers that are substantially continuous or discontinuous, generally smaller than 10 microns in diameter, and generally tacky when deposited onto a collecting surface.

As used herein, the term “spunbond web” generally refers to a web containing small diameter substantially continuous fibers. The fibers are formed by extruding a molten thermoplastic material from a plurality of fine, usually circular, capillaries of a spinnerette with the diameter of the extruded fibers then being rapidly reduced as by, for example, eductive drawing and/or other well-known spunbonding mechanisms. The production of spunbond webs is described and illustrated, for example, in U.S. Pat. No. 4,340,563 to Appel, et al., U.S. Pat. No. 3,692,618 to Dorschner, et al., U.S. Pat. No. 3,802,817 to Matsuki, et al., U.S. Pat. No. 3,338,992 to Kinney, U.S. Pat. No. 3,341,394 to Kinney, U.S. Pat. No. 3,502,763 to Hartman, U.S. Pat. No. 3,502,538 to Levy, U.S. Pat. No. 3,542,615 to Dobo, et al., and U.S. Pat. No. 5,382,400 to Pike, et al., which are incorporated herein in their entirety by reference thereto for all purposes. Spunbond fibers are generally not tacky when they are deposited onto a collecting surface. Spunbond fibers may sometimes have diameters less than about 40 microns, and are often between about 5 to about 20 microns.

As used herein, the term “coform” generally refers to composite materials comprising a mixture or stabilized matrix of thermoplastic fibers and a second non-thermoplastic material. As an example, coform materials may be made by a process in which at least one meltblown die head is arranged near a chute through which other materials are added to the web while it is forming. Such other materials may include, but are not limited to, fibrous organic materials such as woody or non-woody pulp such as cotton, rayon, recycled paper, pulp fluff and also superabsorbent particles, inorganic and/or organic absorbent materials, treated polymeric staple fibers and so forth. Some examples of such coform materials are disclosed in U.S. Pat. No. 4,100,324 to Anderson et al.; U.S. Pat. No. 5,284,703 to Everhart, at al.; and U.S. Pat. No. 5,350,624 to Georger, et al.; which are incorporated herein in their entirety by reference thereto for all purposes.

As used herein, the term “multicomponent fibers” generally refers to fibers that have been formed from at least two polymer components. Such fibers are typically extruded from separate extruders, but spun together to form one fiber. The polymers of the respective components are typically different, but may also include separate components of similar or identical polymeric materials. The individual components are typically arranged in substantially constantly positioned distinct zones across the cross-section of the fiber and extend substantially along the entire length of the fiber. The configuration of such fibers may be, for example, a side-by-side arrangement, a pie arrangement, or any other arrangement. Multicomponent fibers and methods of making the same are taught in U.S. Pat. No. 5,108,820 to Kaneko, at al., U.S. Pat. No. 4,795,668 to Kruege, et al., U.S. Pat. No. 5,382,400 to Pike at al., U.S. Pat. No. 5,336,552 to Strack, at al., and U.S. Pat. No. 6,200,669 to Marmon, et al., which are incorporated herein in their entirety by reference thereto for all purposes. The fibers and individual components containing the same may also have various irregular shapes such as those described in U.S. Pat. No. 5,277,976 to Hogle, et al., U.S. Pat. No. 5,162,074 to Hills, U.S. Pat. No. 5,466,410 to Hills, U.S. Pat. No. 5,069,970 to Largman, et al., and U.S. Pat. No. 5,057,368 to Largman, et al., which are incorporated herein in their entirety by reference thereto for all purposes.

As used herein, the terms “elastomeric” and “elastic” refer to a material that, upon application of a stretching force, is stretchable in at least one direction (such as the CD direction), and which upon release of the stretching force, contracts/returns to approximately its original dimension. For example, a stretched material may have a stretched length that is at least 50% greater than its relaxed unstretched length, and which will recover to within at least 50% of its stretched length upon release of the stretching force. A hypothetical example would be a one (1) inch sample of a material that is stretchable to at least 1.50 inches and which, upon release of the stretching force, will recover to a length of not more than 1.25 inches. Desirably, such elastomeric sheet contracts or recovers at least 50%, and even more desirably, at least 80% of the stretch length in the cross machine direction.

As used herein, the term “breathable” means pervious to water vapor and gases, but impermeable to liquid water. For instance, “breathable barriers” and “breathable films” allow water vapor to pass therethrough, but are substantially impervious to liquid water. The “breathability” of a material is measured in terms of water vapor transmission rate (WVTR), with higher values representing a more vapor-pervious material and lower values representing a less vapor-pervious material. Typically, the “breathable” materials have a water vapor transmission rate (WVTR) of from about 500 to about 20,000 grams per square meter per 24 hours (g/m²/24 hours), in some embodiments from about 1,000 to about 15,000 g/m²/24 hours, and in some embodiments, from about 1,500 to about 14.000 g/m²/24 hours.

As used herein, an “absorbent article” refers to any article capable of absorbing water or other fluids. Examples of some absorbent articles include, but are not limited to, personal care absorbent articles, such as diapers, training pants, absorbent underpants, adult incontinence products, feminine hygiene products (e.g., sanitary napkins), swim wear, baby wipes, and so forth; medical absorbent articles, such as garments, fenestration materials, underpads, bandages, absorbent drapes, and medical wipes; food service wipers; clothing articles; and so forth. Materials and processes suitable for forming such absorbent articles are well known to those skilled in the art.

As used herein, the term “hydrophobic substrate” is meant to include any shaped article, provided it is composed, in whole or in part, of a hydrophobic polymer and the term “porous hydrophobic substrate” is meant to include any substrate, provided it is porous and composed, in whole or in part, of a hydrophobic polymer. For example, the hydrophobic substrate may be a sheet-like material, such as a sheet of a foamed material. The hydrophobic substrate also may be a fibrous fabric, such as fibrillated film or a woven or nonwoven web or fabric. These structures can be predominately hydrophobic or can be selectively treated exhibiting different hydrophobic zones. Nonwoven fabrics include, but are not limited to, a meltblown fabric, a spunbonded fabric, a carded fabric or an airlaid fabric. The hydrophobic substrate also may be a laminate of two or more layers of a sheet-like material. For example, the layers may be independently selected from the group consisting of meltblown fabrics and spunbonded fabrics. However, other sheet-like materials such as films or foams may be used in addition to, or instead of, meltblown and spunbonded fabrics. In addition, the layers of the laminate may be prepared from the same hydrophobic polymer or different hydrophobic polymers.

The term “hydrophobic polymer” is used herein to mean any polymer resistant to wetting, or not readily wet, by water, i.e., having a lack of affinity for water. Examples of hydrophobic polymers include, by way of illustration only, polyolefins, such as polyethylene, poly(isobutene), poly(isoprene), poly(4-methyl-1-pentene), polypropylene, ethylene-propylene copolymers, ethylene-propylene-hexadiene copolymers, and ethylene-vinyl acetate copolymers; styrene polymers, such as poly(styrene), poly(2-methylstyrene), styrene-acrylonitrile copolymers having less than about 20 mol-percent acrylonitrile, and styrene-2,2,3,3-tetrafluoropropyl methacrylate copolymers; halogenated hydrocarbon polymers, such as poly(chlorotrifluoroethylene), chlorotrifluoroethylene-tetrafluoroethylene copolymers, poly(hexafluoropropylene), poly(tetrafluoroethylene), tetrafluoroethylene-ethylene copolymers, poly(trifluoroethylene), poly(vinyl fluoride), and poly(vinylidene fluoride); vinyl polymers, such as poly(vinyl butyrate), poly(vinyl decanoate), poly(vinyl dodecanoate), poly(vinyl hexadecanoate), poly(vinyl hexanoate), poly(vinyl propionate), poly(vinyl octanoate), poly(heptafluoroisopropoxyethylene), poly(heptafluoroisopropoxypropylene), and poly(methacrylonitrile); acrylic polymers, such as poly(n-butyl acetate), poly(ethyl acrylate), poly[(1-chlorodifluoromethyl)tetrafluoroethyl acrylate], poly[di(chlorofluoromethyl)fluoromethyl acrylate], poly(1,1-dihydroheptafluorobutyl acrylate), poly(1,1-dihydropentafluoroisopropyl acrylate), poly(1,1-dihydropentadecafluorooctyl acrylate), poly(heptafluoroisopropyl acrylate), poly[5-(heptafluoroisopropoxy)pentyl acrylate], poly[11-(heptafluoroisopropoxy)undecyl acrylate], poly[2-(heptafluoropropoxy)ethyl acrylate], and poly(nonafluoroisobutyl acrylate); methacrylic polymers, such as poly(benzyl methacrylate), poly(n-butyl methacrylate), poly(isobutyl methacrylate), poly(t-butyl methacrylate), poly(t-butylaminoethyl methacrylate), poly(dodecyl methacrylate), poly(ethyl methacrylate), poly(2-ethylhexyl methacrylate), poly(n-hexyl methacrylate), poly(phenyl methacrylate), poly(n-propyl methacrylate), poly(octadecyl methacrylate), poly(1,1-dihydropentadecafluorooctyl methacrylate), poly(heptafluoroisopropyl methacrylate), poly(heptadecafluorooctyl methacrylate), poly(1-hydrotetrafluoroethyl methacrylate), poly(1,1-dihydrotetrafluoropropyl methacrylate), poly(1-hydrohexafiuoroisopropyl methacrylate), and poly)ₜ-nonafluorobutyl methacrylate); and polyesters, such a polyethylene terephthalate) and poly(butylene terephthalate).

### DETAILED DESCRIPTION

Reference now will be made to the embodiments of the invention, one or more examples of which are set forth below. Each example is provided by way of an explanation of the invention, not as a limitation of the invention. In fact, it will be apparent to those skilled in the art that various modifications and variations can be made in the invention without departing from the scope or spirit of the invention. For instance, features illustrated or described as one embodiment can be used on another embodiment to yield still a further embodiment. Thus, it is intended that the present invention cover such modifications and variations as come within the scope of the appended claims and their equivalents. It is to be understood by one of ordinary skill in the art that the present discussion is a description of exemplary embodiments only, and is not intended as limiting the broader aspects of the present invention, which broader aspects are embodied exemplary constructions.

In general, the present disclosure is directed to a printed nonwoven web of synthetic fibers treated with an external softening agent. The web exhibits improved softness when a softening agent is applied over a graphic on a visible outer surface of the nonwoven web. For example, the nonwoven web demonstrates improved softness when subjected to a static coefficient of friction test. As another example, the nonwoven web demonstrates improved softness when subjected to a dynamic coefficient of friction test. As a further example, the nonwoven web demonstrates improved softness without sacrificing any durability in that the nonwoven web demonstrates good durability when subjected to a Crockfastness test.

In one embodiment, the printed and treated surface of the nonwoven web can be the visible surface of a laminate. For example, the printed and treated surface can be an outward facing surface (e.g., outer visible surface) of an outercover film-web laminate of an absorbent article. As such, the graphic and softness treatment composition can be applied directly onto the outer facing nonwoven surface of the outer cover, instead of on an underlying layer of the outer cover laminate (e.g., a filmy

### A. Substrates

The substrates to which the graphic and softening treatment may be applied include any known sheet-like substrate, such as films, nonwoven webs (e.g., spunbond webs, meltblown webs, and so forth), etc. The substrate may contain a single layer or multiple layers and may also contain additional materials such that it is considered a composite. In one embodiment, the substrate may be a nonwoven web of synthetic fibers. The synthetic fibers can generally be hydrophobic fibers. In one particular embodiment, the fibers of the nonwoven web are primarily hydrophobic synthetic fibers. For example, greater than about 90% of the fibers of the web can be hydrophobic synthetic fibers, such as greater than about 95%. In one embodiment, substantially all of the fibers of the nonwoven web (i.e., greater than about 98%, greater than about 99%, or about 100%) are hydrophobic synthetic fibers.

The nonwoven web can be made by any number of processes. As a practical matter, however, the nonwoven fabrics and the fibers that make up nonwoven fabrics usually will be prepared by a melt-extrusion process and formed into the nonwoven fabric. The term melt-extrusion process includes, among others, such well-known processes as meltblowing and spunbonding. Other methods for preparing nonwoven fabrics are, of course, known and may be employed. Such methods include air laying, wet laying, carding, and so forth. In some cases it may be either desirable or necessary to stabilize the nonwoven fabric by known means, such as thermal point bonding, through-air bonding, and hydroentangling.

As stated, the nonwoven web can primarily include synthetic fibers, particularly synthetic hydrophobic fibers, such as polyolefin fibers. In one particular embodiment, polypropylene fibers can be used to form the nonwoven web. The polypropylene fibers may have a denier per filament of about 1.5 to 2.5, and the nonwoven web may have a basis weight of about 17 grams per square meter (0.5 ounce per square yard). Furthermore, the nonwoven fabric may include bicomponent or other multicomponent fibers. Exemplary multicomponent nonwoven fabrics are described in U.S. Pat. No. 5,382,400 issued to Pike et al., U.S. Publication no. 2003/0118816 entitled “High Loft Low Density Nonwoven Fabrics Of Crimped Filaments And Methods Of Making Same” and U.S. Publication no. 2003/0203162 entitled “Methods For Making Nonwoven Materials On A Surface Having Surface Features And Nonwoven Materials Having Surface Features” which are hereby incorporated by reference herein in their entirety.

Sheath/core bicomponent fibers where the sheath is a polyolefin such as polyethylene or polypropylene and the core is polyester such as poly(ethylene terephthalate) or poly(butylene terephthalate) can also be used to produce carded fabrics or spunbonded fabrics. The primary role of the polyester core is to provide resiliency and thus to maintain or recover bulk under/after load. Bulk retention and recovery plays a role in separation of the skin from the absorbent structure. This separation has shown an effect on skin dryness. The combination of skin separation provided with a resilient structure along with a treatment such of the present invention can provide an overall more efficient material for fluid handling and skin dryness purposes.

If desired, a treatment composition can be applied to the substrate prior to application of the ink composition to further adhere the ink composition to the nonwoven web. Exemplary treatment compositions that can be utilized are disclosed in U.S. Publication No. 2004/0121675 of Snowden et al., U.S. Publication No. 2006/0003150 to Braverman, et al., and U.S. Publication No. 2006/0246263 to Yahiaoui, at al., all of which are herein incorporated by reference.

As stated, the nonwoven web can be included as an outer surface of a laminate. When included as part of a laminate, the nonwoven web generally provides a more cloth-like feeling to the laminate. For example, a film-web laminate can be formed from the nonwoven web overlying a film layer. In one embodiment, for instance, the nonwoven web is thermally laminated to the film to form the film-web laminate. However, any suitable technique can be utilized to form the laminate. Suitable techniques for bonding a film to a nonwoven web are described in U.S. Pat. No. 5,843,057 to McCormack; U.S. Pat. No. 5,855,999 to McCormack; U.S. Pat. No. 6,002,064 to Kobylivker, et al.; U.S. Pat. No. 6,037,281 to Mathis, et al.; and WO 99/12734, which are incorporated herein in their entirety by reference thereto for all purposes.

The film layer of the laminate is typically formed from a material that is substantially impermeable to liquids. For example, the film layer may be formed from a thin plastic film or other flexible liquid-impermeable material. In one embodiment, the film layer is formed from a polyethylene film having a thickness of from about 0.01 millimeter to about 0.05 millimeter. For example, a stretch-thinned polypropylene film having a thickness of about 0.015 millimeter may be thermally laminated to the nonwoven web.

In addition, the film layer may be formed from a material that is impermeable to liquids, but permeable to gases and water vapor (i.e., “breathable”). This permits vapors to pass through the laminate, but still prevents liquid exudates from passing through the laminate. The use of a breathable laminate is especially advantageous when the laminate is used as an outercover of an absorbent article to permit vapors to escape from the absorbent core, but still prevents liquid exudates from passing through the outer cover. For example, the breathable film may be a microporous or monolithic film.

The film may be formed from a polyolefin polymer, such as linear, low-density polyethylene (LLDPE) or polypropylene. Examples of predominately linear polyolefin polymers include, without limitation, polymers produced from the following monomers: ethylene, propylene, 1-butene, 4-methyl-pentene, 1-hexene, 1-octene and higher olefins as well as copolymers and terpolymers of the foregoing. In addition, copolymers of ethylene and other olefins including butene, 4-methyl-pentene, hexene, heptene, octane, decene, etc., are also examples of predominately linear polyolefin polymers.

If desired, the breathable film may also contain an elastomeric polymer, such as elastomeric polyesters, elastomeric polyurethanes, elastomeric polyamides, elastomeric polyolefins, elastomeric copolymers, and so forth. Examples of elastomeric copolymers include block copolymers having the general formula A-B-A′ or A-B, wherein A and A′ are each a thermoplastic polymer endblock that contains a styrenic moiety (e.g., poly(vinyl arene)) and wherein B is an elastomeric polymer midblock, such as a conjugated diene or a lower alkene polymer (e.g., polystyrene-poly(ethylene-butylene)-polystyrene block copolymers). Also suitable are polymers composed of an A-B-A-B tetrablock copolymer, such as discussed in U.S. Pat. No. 5,332,613 to Taylor, et al., which is incorporated herein in its entirety by reference thereto for all purposes. An example of such a tetrablock copolymer is a styrene-poly(ethylene-propylene)-styrene-poly(ethylene-propylene) (“S-EP-S-EP”) block copolymer. Commercially available A-B-A′ and A-B-A-B copolymers include several different formulations from Kraton Polymers of Houston, Tex. under the trade designation KRATON®. KRATON® block copolymers are available in several different formulations, a number of which are identified in U.S. Pat. Nos. 4,663,220, 4,323,534, 4,834,738, 5,093,422 and 5,304,599, which are hereby incorporated in their entirety by reference thereto for all purposes. Other commercially available block copolymers include the S-EP-S or styrene-poly(ethylene-propylene)-styrene elastomeric copolymer available from Kuraray Company, Ltd. of Okayama, Japan, under the trade name SEPTON®. Examples of elastomeric polyolefins include ultra-low density elastomeric polypropylenes and polyethylenes, such as those produced by “single-site” or “metallocene” catalysis methods. Such elastomeric olefin polymers are commercially available from ExxonMobil Chemical Co. of Houston, Tex. under the trade designations ACHIEVE® (propylene-based), EXACT® (ethylene-based), and EXCEED® (ethylene-based). Elastomeric olefin polymers are also commercially available from DuPont Dow Elastomers, LLC (a joint venture between DuPont and the Dow Chemical Co.) under the trade designation ENGAGE® (ethylene-based) and AFFINITY® (ethylene-based). Examples of such polymers are also described in U.S. Pat. Nos. 5,278,272 and 5,272,236 to Lai, et al., which are incorporated herein in their entirety by reference thereto for all purposes. Also useful are certain elastomeric polypropylenes, such as described in U.S. Pat. No. 5,539,056 to Yang, et al. and U.S. Pat. No. 5,596,052 to Resconi, et al., which are incorporated herein in their entirety by reference thereto for all purposes.

If desired, blends of two or more polymers may also be utilized to form the breathable film. For example, the film may be formed from a blend of a high performance elastomer and a lower performance elastomer. A high performance elastomer is generally an elastomer having a low level of hysteresis, such as less than about 75%, and in some embodiments, less than about 60%. Likewise, a low performance elastomer is generally an elastomer having a high level of hysteresis, such as greater than about 75%. The hysteresis value may be determined by first elongating a sample to an ultimate elongation of 50% and then allowing the sample to retract to an amount where the amount of resistance is zero. Particularly suitable high performance elastomers may include styrenic-based block copolymers, such as described above and commercially available from Kraton Polymers of Houston, Tex. under the trade designation KRATON®. Likewise, particularly suitable low performance elastomers include elastomeric polyolefins, such as metallocene-catalyzed polyolefins (e.g., single site metallocene-catalyzed linear low density polyethylene) commercially available from DuPont Dow Elastomers, LLC under the trade designation AFFINITY®. In some embodiments, the high performance elastomer may constitute from about 25 wt. % to about 90 wt. % of the polymer component of the film, and the low performance elastomer may likewise constitute from about 10 wt. % to about 75 wt. % of the polymer component of the film. Further examples of such a high performance/low performance elastomer blend are described in U.S. Pat. No. 6,794,024 to Walton, et al., which is incorporated herein in its entirety by reference thereto for all purposes.

As stated, the breathable film may be microporous. The micropores form what is often referred to as tortuous pathways through the film. Liquid contacting one side of the film does not have a direct passage through the film. Instead, a network of microporous channels in the film prevents liquids from passing, but allows gases and water vapor to pass. Microporous films may be formed from a polymer and a filler (e.g., calcium carbonate). Fillers are particulates or other forms of material that may be added to the film polymer extrusion blend and that will not chemically interfere with the extruded film, but which may be uniformly dispersed throughout the film. Generally, on a dry weight basis, based on the total weight of the film, the film includes from about 30% to about 90% by weight of a polymer. In some embodiments, the film includes from about 30% to about 90% by weight of a filler. Examples of such films are described in U.S. Pat. No. 5,843,057 to McCormack; U.S. Pat. No. 5,855,999 to McCormack; U.S. Pat. No. 5,932,497 to Morman, et al.; U.S. Pat. No. 5,997,981 to McCormack et al.; U.S. Pat. No. 6,002,064 to Kobylivker, et al.; U.S. Pat. No. 6,015,764 to McCormack et al.; U.S. Pat. No. 6,037,281 to Mathis et al.; U.S. Pat. No. 6,111,163 to McCormack et al.; and U.S. Pat. No. 6,461,457 to Taylor et al., which are incorporated herein in their entirety by reference thereto for all purposes.

The films are generally made breathable by stretching the filled films to create the microporous passageways as the polymer breaks away from the filler (e.g., calcium carbonate) during stretching. For example, the breathable material contains a stretch-thinned film that includes at least two basic components, i.e., a polyolefin polymer and filler. These components are mixed together, heated, and then extruded into a film layer using any one of a variety of film-producing processes known to those of ordinary skill in the film processing art. Such film-making processes include, for example, cast embossed, chill and flat cast, and blown film processes.

Another type of breathable film is a monolithic film that is a nonporous, continuous film, which because of its molecular structure, is capable of forming a liquid-impermeable, vapor-permeable barrier. Among the various polymeric films that fall into this type include films made from a sufficient amount of poly(vinyl alcohol), polyvinyl acetate, ethylene vinyl alcohol, polyurethane, ethylene methyl acrylate, and ethylene methyl acrylic acid to make them breathable. Without intending to be held to a particular mechanism of operation, it is believed that films made from such polymers solubitize water molecules and allow transportation of those molecules from one surface of the film to the other. Accordingly, these films may be sufficiently continuous, i.e., nonporous, to make them substantially liquid-impermeable, but still allow for vapor permeability.

Breathable films, such as described above, may constitute the entire breathable material, or may be part of a multilayer film. Multilayer films may be prepared by cast or blown film coextrusion of the layers, by extrusion coating, or by any conventional layering process. Further, other breathable materials that may be suitable for use in the present invention are described in U.S. Pat. No. 4,341,216 to Obenour; U.S. Pat. No. 4,758,239 to Yeo, et al.; U.S. Pat. No. 5,628,737 to Dobrin, et al.; U.S. Pat. No. 5,836,932 to Buell; U.S. Pat. No. 6,114,024 to Forte; U.S. Pat. No. 6,153,209 to Vega, et al.; U.S. Pat. No. 6,198,018 to Curro; U.S. Pat. No. 6,203,810 to Alemany, et al.; and U.S. Pat. No. 6,245,401 to Ying, et al., which are incorporated herein in their entirety by reference thereto for all purposes.

In one embodiment, the laminate consists only of two layers: the nonwoven web and the film. On the other hand, in some embodiments, other layers may be included in the laminate, so long as the nonwoven web defines an outer surface of the laminate for receiving the ink composition and the softening agent. When present, the other layer(s) of the laminate can include, nonwoven webs, films, foams, etc.

In one particular embodiment, the nonwoven web is suitable for use as a layer of a backsheet laminate (i.e., outercover) of an absorbent article. The backsheet of absorbent articles is typically a liquid impermeable sheet, and may also be breathable. For example, in one particular embodiment, the backsheet is a laminate of a liquid impervious film attached to a nonwoven web of polyolefin fibers.

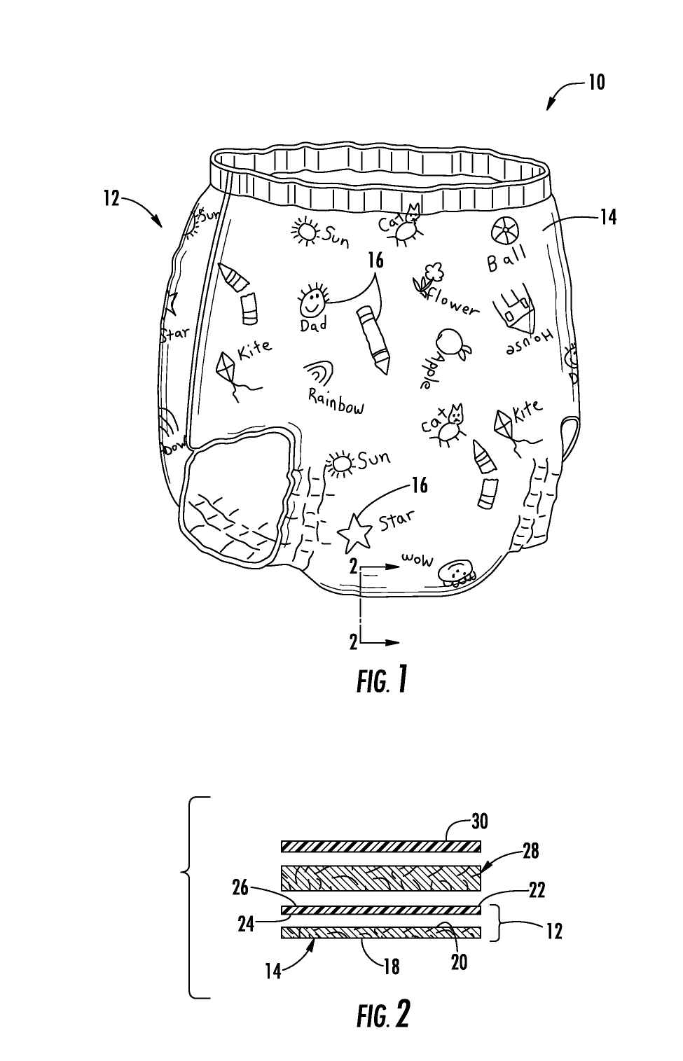

An exemplary printed nonwoven web laminate used in the construction of an exemplary training pant is illustrated in FIGS. 1, 2, and 3 a-c. FIG. 1 is a perspective view of an exemplary training pant 10, and FIG. 2 is an exploded cross-sectional view of FIG. 1 taken along line 2-2. It is an outer visible surface 18 of a nonwoven web 14 that presents or forms the outermost, visible surface of a training pant 10 and on which images 16 are printed. The illustrated exemplary printed nonwoven web 14 is utilized as the outward facing layer of a backsheet 12 of the training pant 10, but could be incorporated on any of a variety of absorbent articles upon which printed information or designs might be desirable including, but not limited to, diapers, feminine care products, incontinence products, training pants, swimming pants, and so forth.

For example, in FIGS. 1 and 2, the training pant 10 comprises the backsheet 12, which can be a two-layered laminate that includes a nonwoven polyolefin fibrous web 14 suitably joined to a liquid impervious film 22. The web 14 has opposed surfaces such as an inner surface 20 and an outer visible surface 18. A film 22 has opposed surfaces such as a surface 24 facing an inner surface 20 of the web 14 and a surface 26 that faces toward an absorbent composite 26.

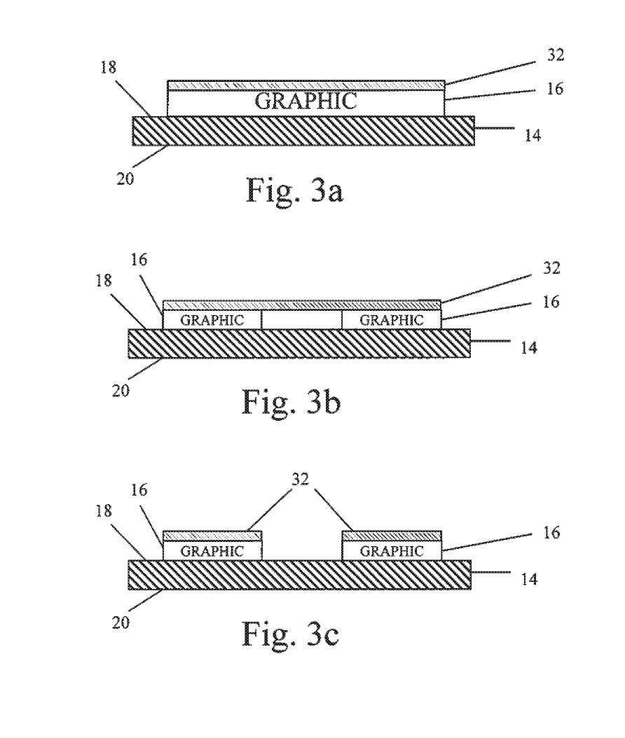

One way to make these products more appealing is to print in bright colors on the products. FIGS. 3 a-c depict cross-sectional views of a several configurations of printed nonwoven webs 14. Any desired design or other image 16 can be applied or printed on the outer visible surface 18 defined by the nonwoven web 14 using a suitable ink composition. For example, a number of intricate, registered images can be printed on the outer visible surface 18 of the backsheet 12. The softening agent 32 is then applied over the ink composition that forms the graphical image 16. By outer “visible” surface is meant that surface of the product that is visible when the product is worn (i.e., the exposed outer surface of the absorbent article). As stated, the inclusion of a crosslinking agent in the ink composition can inhibit the design from rubbing off during use of the article. As such, the designs can resist fading on the outercover, as well as preventing staining of anything (e.g., skin) that contacts the outercover. In the embodiment depicted in FIG. 3a, both the graphic image 16 and the softening agent 32 are shown extending across the outer visible surface 18 of the nonwoven 14. In another embodiment depicted in FIG. 3b, discrete graphics 16 are depicted on the outer visible surface 18 of the nonwoven 14. The softening agent 32 extends from one discrete graphic 16 to the next as the softening agent extends across the outer visible surface 18. In a further embodiment depicted in FIG. 3c, discrete graphics 16 are depicted on the outer visible surface 18 of the nonwoven 14 with discrete areas of softening agent 32 applied in a pattern similar to that of the discrete graphics.

A liquid permeable topsheet 30 (i.e., the bodyside liner) is positioned on the side of the absorbent core 28 opposite to the backsheet 12, and is the layer that is against the skin of the wearer.

The liquid permeable topsheet 30 is generally employed to help isolate the wearer's skin from liquids held in the absorbent core 28. For example, the liquid permeable topsheet 30 presents a bodyfacing surface that is typically compliant, soft feeling, and non-irritating to the wearer's skin. Typically, the liquid permeable topsheet 30 is also less hydrophilic than the absorbent core 28 so that its surface remains relatively dry to the wearer. The liquid permeable topsheet 30 permits liquid to readily penetrate through its thickness.

The liquid permeable topsheet 30 may be formed from a wide variety of materials, such as porous foams, reticulated foams, apertured plastic films, natural fibers (e.g., wood or cotton fibers), synthetic fibers (e.g., polyester or polypropylene fibers), or a combination thereof. In some embodiments, woven and/or nonwoven fabrics are used for the liquid permeable topsheet 30. For example, the liquid permeable topsheet 30 may be formed from a meltblown or spunbonded web of polyolefin fibers. The liquid permeable topsheet 30 may also be a bonded-carded web of natural and/or synthetic fibers. The liquid permeable topsheet 30 may further be composed of a substantially hydrophobic material that is optionally treated with a surfactant or otherwise processed to impart a desired level of wettability and hydrophilicity. The surfactant may be applied by any conventional method, such as spraying, printing, brush coating, foaming, and so forth. When utilized, the surfactant may be applied to the entire liquid permeable topsheet 30 or may be selectively applied to particular sections of the liquid permeable topsheet 30, such as to the medial section along the longitudinal centerline of the diaper. The liquid permeable topsheet 30 may further include a composition that is configured to transfer to the wearer's skin for improving skin health. Suitable compositions for use on the liquid permeable topsheet 30 are described in U.S. Pat. No. 6,149,934 to Krzysik et al., which is incorporated herein in its entirety by reference thereto for all purposes.

The absorbent core 28 may be formed from a variety of materials, but typically includes a matrix of hydrophilic fibers. In one embodiment, an absorbent web is employed that contains a matrix of cellulosic fluff fibers. One type of fluff that may be used in the present invention is identified with the trade designation CR1654, available from U.S. Alliance of Childersburg, Ala., and is a bleached, highly absorbent sulfate wood pulp containing primarily softwood fibers. Airlaid webs may also be used. In an airlaying process, bundles of small fibers having typical lengths ranging from about 3 to about 19 millimeters are separated and entrained in an air supply and then deposited onto a forming screen, usually with the assistance of a vacuum supply. The randomly deposited fibers then are bonded to one another using, for example, hot air or a spray adhesive. Another type of suitable absorbent nonwoven web for the absorbent core 28 is a coform material which may be a blend of cellulose fibers and meltblown fibers.

In some embodiments, the absorbent core 28 may contain a superabsorbent material, e.g., a water-swellable material capable of absorbing at least about 20 times its weight and, in some cases, at least about 30 times its weight in an aqueous solution containing 0.9 weight percent sodium chloride. The superabsorbent materials may be natural, synthetic and modified natural polymers and materials. In addition, the superabsorbent materials may be inorganic materials, such as silica gels, or organic compounds such as cross-linked polymers. Examples of synthetic superabsorbent material polymers include the alkali metal and ammonium salts of poly(acrylic acid) and poly(methacrylic acid), poly(acrylamides), poly(vinyl ethers), maleic anhydride copolymers with vinyl ethers and alpha-olefins, poly(vinyl pyrrolidone), poly(vinylmorpholinone), poly(vinyl alcohol), polyacrylamido-methyl propane sulfonic acid and salt, and mixtures and copolymers thereof. Further superabsorbent materials include natural and modified natural polymers, such as hydrolyzed acrylonitrile-grafted starch, acrylic acid grafted starch, methyl cellulose, chitosan, carboxymethyl cellulose, hydroxypropyl cellulose, and the natural gums, such as alginates, xanthan gum, locust bean gum and so forth. Mixtures of natural and wholly or partially synthetic superabsorbent polymers may also be useful in the present invention. Other suitable absorbent gelling materials are disclosed in U.S. Pat. No. 3,901,236 to Assarsson et al.; U.S. Pat. No. 4,076,663 to Masuda et al.; and U.S. Pat. No. 4,286,082 to Tsubakimoto et al., which are incorporated herein in their entirety by reference thereto for all purposes.

Although not specifically illustrated, absorbent articles, such as the exemplary training pant shown in FIG. 1, may also include other layers not illustrated. For example, a surge layer can be included in the construction of the article to help decelerate and diffuse surges or gushes of liquid that may be rapidly introduced into the absorbent core 28. Desirably, the surge layer can rapidly accept and temporarily hold the liquid prior to releasing it into the storage or retention portions of the absorbent core 28. Typically, when included in the article, the surge layer is interposed between liquid permeable topsheet and the absorbent core. Alternatively, the surge layer may be located on an outwardly facing surface of the liquid permeable topsheet. The surge layer is typically constructed from highly liquid-permeable materials. Suitable materials may include porous woven materials, porous nonwoven materials, and apertured films. Some examples include, without limitation, flexible porous sheets of polyolefin fibers, such as polypropylene, polyethylene or polyester fibers; webs of spunbonded polypropylene, polyethylene or polyester fibers; webs of rayon fibers; bonded carded webs of synthetic or natural fibers or combinations thereof. Other examples of suitable surge layers are described in U.S. Pat. No. 5,486,166 to Ellis, et al. and U.S. Pat. No. 5,490,846 to Ellis, et al., which are incorporated herein in their entirety by reference thereto for all purposes.

Besides the above-mentioned components, absorbent articles may also contain various other components as is known in the art. For example, the absorbent article may also contain a substantially hydrophilic tissue wrapsheet (not illustrated) that helps maintain the integrity of the airlaid fibrous structure of the absorbent core. The tissue wrapsheet is typically placed about the absorbent core over at least the two major facing surfaces thereof, and composed of an absorbent cellulosic material, such as creped wadding or a high wet-strength tissue. The tissue wrapsheet may be configured to provide a wicking layer that helps to rapidly distribute liquid over the mass of absorbent fibers of the absorbent core. The wrapsheet material on one side of the absorbent fibrous mass may be bonded to the wrapsheet located on the opposite side of the fibrous mass to effectively entrap the absorbent core. More detailed descriptions of training pants can be found in U.S. Pat. No. 4,940,464, the entire contents of which are hereby incorporated by reference herein.

### B. Ink Compositions

Ink compositions can be applied in a solution form, such as in an aqueous solution, an organic solvent solution, or in mixed aqueous/organic solvent systems. Typically, aqueous based ink compositions are most widely used with digital printing, while solvent based inks are most widely used with flexographic printing. However, solvent based inks can also be used with digital processes, and water based inks are commonly used with flexographic printing. In the digital ink processes, the inks are difficult to formulate because the ink composition is constrained to a choice of ingredients. The digital inks and digital processes have narrow tolerances in terms of pH, viscosity, surface tension, purity, and other physical and chemical properties. Also, ink compositions used in digital ink processes typically have a low solid content which can create difficulty in drying the ink composition onto the polymeric substrate, especially in the high speed printing process.

In some embodiments, the ink composition may contain a crosslinking agent in an amount sufficient to crosslink molecules within the ink composition. As such, the ink composition becomes more coherent once applied to the substrate. For example, the ink composition can crosslink to form a 3-dimensional chemical structure once applied to the substrate. The 3-dimensional structure of the ink composition can inhibit the ink composition from rubbing off of the substrate through mechanical forces. For example, when applied to a nonwoven fabric, the ink composition can form a crosslinked structure that wraps around the fibers of the nonwoven fabric, effectively inhibiting the crosslinked ink composition from rubbing off of the fibers.

Additionally, the crosslinking agent may crosslink molecules within the ink composition to suitable sites on substrate itself. Thus, the ink composition can be chemically bonded to the substrate and inhibited from rubbing off of the fibers through chemical forces. For instance, when applied to a nonwoven web, the molecules within the ink composition can bond to polymers within the fibers of the nonwoven web.

Adding a relatively high amount of the crosslinking agent to the ink composition dramatically increases the oil crockfastness of the ink composition applied to the substrate. For example, the crosslinking agent can be added to the ink composition in an amount of greater than about 2% by weight based on the wet weight of the ink composition, such as greater than about 4% by weight. In some embodiments, the crosslinking agent can be present in an amount of from about 5% by weight to about 20% by weight, such as from about 7% by weight to about 15% by weight. For example, in one particular embodiment, the crosslinking agent can be present at about 10% to about 12% by weight in the ink composition. It should be noted that after application of the ink composition to the laminate, the dried ink composition may contain a greater percentage by dry weight of the crosslinking agent due to the solvent evaporating.

The crosslinking agent can be selected from those agents configured to crosslink the ink composition to form a three dimensional chemical structure. Additionally, the crosslinking agent can facilitate bonding between the ink composition and the fibers of the nonwoven web. Examples of suitable crosslinking agents that may be used include, but are not limited to, XAMA-2, XAMA-7, and CX-100, which are available commercially from Noveon, Inc. of Cleveland, Ohio. These materials are aziridine oligomers with at least two aziridine functional groups. More detailed descriptions of ink compositions can be found in U.S. Patent Application No. 200810227356, the entire contents of which are hereby incorporated by reference herein.

Additionally, other adhesion promoters can be added to the ink composition. For example, Carboset 514H, available commercially from Noveon, Inc. of Cleveland. Ohio, is an acrylic colloidal dispersion polymer supplied in ammonia water, which can dry to a clear, water-resistant, non-tacky thermoplastic film.

In addition to the crosslinking agent, the ink compositions can generally contain a coloring agent (e.g., pigment or dye), a solvent, and any other desired ingredients. Typically, a pigment refers to a colorant based on inorganic or organic particles which do not dissolve in water or solvents. Usually pigments form an emulsion or a suspension in water. On the other hand, a dye generally refers to a colorant that is soluble in water or solvents.

The pigment or dye in the ink composition can be present in an amount effective to provide a visible mark once applied to the substrate. For example, the pigment or dye can be present in the ink composition at concentration between about 0.25% to about 40% based on the dry weight basis, and preferably between greater than or equal to about 1% and less than or equal to about 10%.

Suitable organic pigments, include dairylide yellow AAOT (for example, Pigment Yellow 14 CI No. 21 095), dairylide yellow AAOA (for example, Pigment Yellow 12 CI No. 21090), Hansa Yellow, CI Pigment Yellow 74, Phthalocyanine Blue (for example, Pigment Blue 15), lithol red (for example, Pigment Red 52:1 CI No. 15860: 1). toluidine red (for example. Pigment Red 22 CI No. 12315), dioxazine violet (for example, Pigment Violet 23 CI No. 51319), phthalocyanine green (for example, Pigment Green 7 CI No. 74260), phthalocyanine blue (for example, Pigment Blue 15 CI No. 74160), naphthoic acid red (for example, Pigment Red 48:2 CI No. 15865:2). Inorganic pigments include titanium dioxide (for example, Pigment White 6 CI No. 77891), carbon black (for example, Pigment Black 7 CI No. 77266), iron oxides (for example, red, yellow, and brown), ferric oxide black (for example, Pigment Black 11 CI No. 77499), chromium oxide (for example, green), ferric ammonium ferrocyanide (for example, blue), and the like.

Suitable dyes that may be used with the additive of the present invention include, for instance, acid dyes, and sulfonated dyes including direct dyes. Other suitable dyes include azo dyes (e.g., Solvent Yellow 14, Dispersed Yellow 23, and Metanil Yellow), anthraquinone dyes (e.g., Solvent Red 111, Dispersed Violet 1, Solvent Blue 56, and Solvent Orange 3), xanthene dyes (e.g., Solvent Green 4, Acid Red 52, Basic Red 1, and Solvent Orange 63), azine dyes (e.g., Jet Black), and the like.

The inks are generally dispersed or dissolved in a low viscosity carrier. Exemplary solvents are aliphatic hydrocarbons with common binder types, such as polyamide, shellac, nitro-cellulose, and styrene-maleic. Generally, solvent-based inks include non-catalytic, block urethane resin, which generally demonstrate superior durability over traditional flexographic binders, such as styrene-maleic, rosin-maleic, and acrylic solutions. Desired solvent blends include various acetates such as ethyl acetate, N-propyl acetate, isopropyl acetate, isobutyl acetate, N-butyl acetate, and blends thereof; various alcohols including ethyl alcohol, isopropyl alcohol, normal propyl alcohol, and blends thereof; and glycol ethers including Ektasolve® EP (ethylene glycol monopropyl ether), EB (ethylene glycol monobutyl ether), DM (diethylene glycol monomethyl ether), DP (diethylene glycol monopropyl ether), and PM (propylene glycol monomethyl ether), which may be obtained from Eastman Chemical of Kingsport, Tenn. Other glycols that may also be used are DOWANOL® obtainable from Dow Chemical of Midland, Mich. A desired solvent blend may be a blend of about 50 percent to about 75 percent glycol ether, about 25 percent to about 35 percent N-propyl acetate, and about 15 percent to about 25 percent N-butyl acetate.

Suitable water-based inks that may be used include emulsions that may be stabilized in water-ammonia and may further comprise alcohols, glycols, or glycol ethers as co-solvents. Generally, organic solvents (less than equal to about 7 percent) to water-based inks: alcohols, for example, propan-2-ol may be added for speeding up drying and assisting wetting, glycols, for example, mono propylene glycol to slow down drying, glycol ethers, for example, dipropyl glycol mono methyl ether to aid film formation. Such solvents may be commodity chemicals, commercially available from various companies. Generally, water-based ink includes self-crosslinking acrylic copolymer emulsion, which may have demonstrated superior durability over traditional non-crosslinking binders such as acrylic solutions and dispersion copolymers. Besides the solvent and pigments, the inks may comprise a binder or mixtures thereof. The binder helps stabilize the pigment onto the cover layer 12. Generally, the pigment-to-binder ratios is typically from 1:20 to 1:2.

Waxes may also be included in the ink composition to increase the slip and improve the rub-resistance of the inks of the printed polyolefin substrate. Common classifications of waxes include animal (for example, beeswax and lanolin), vegetable (for example, carnauba and candellilia), mineral (for example, paraffin and microcrystalline), and synthetic (for example. Polyethylene, polyethylene glycol, and Teflon®). In one embodiment, a wax can be present in an amount of about 0.5 percent to about 5 percent based on the total ink formulation weight when wet.

In one embodiment, the ink compositions used in the printing process to form the indicia are particulate-type ink compositions. The inks chosen should, of course, be safe for human use and should not have environmentally deleterious effects. Moreover, it is desirable that the ink composition is suitable for the intended printing process and is preferably temperature resistant to the process employed for forming the absorbent article, e.g., the temperatures used during a vacuum aperturing process and the like elevated heating processes.

The particular method of printing the ink composition onto the nonwoven web can be any suitable printing method, including flexographic, gravure, offset, ink-jet, etc. The printing method can be used to print any design, figure, or other image on the surface of the nonwoven web.

As well known in the art, each printing process generally requires a specific ink composition specially formulated for that particular printing process. The particular ink formulations generally compensate for differing printing conditions between different printing processes and differing print substrates. For example, ink compositions for ink-jet printing are considerably different than ink compositions for flexographic printing due in part to different types of printing systems used in the two processes.

For instance, flexographic inks are not limited by the type of coloring agent and can utilized dyes and/or pigments, even those pigments that contain a relatively large particle size. However, ink jet printing inks are generally limited to particle-free ink compositions, or at least those with a relatively small particle size. As such, ink jet inks typically include dyes as opposed to pigments as the coloring agent in the ink composition.

### C. Softening Agents

The substrate further includes a softening agent overlaying the ink composition. The softening agent may be present in a continuous layer over the entire external surface of the printed substrate. Alternatively, the softening agent may be present in a pattern on the printed external surface of the printed surface. In one embodiment, the softening is present on the printed surface of the nonwoven in a pattern that coincides with a printed pattern on the surface of the nonwoven. Desirably the softening agent is transparent or substantially transparent to permit the underlying printed pattern or graphic to be visible through the softening agent.

Suitably, the softening agent may be selected from the group consisting of erucamide, cetyl 2-ethylhexanone, ethylhexyl stearate, ethylhexyl hydroxyetarate, and perfluorinated dimethicone. Further, the softening agent may be selected from the group consisting of polyethylene waxes such as a polyethylene wax, glyceryl monostearate, sorbitan tristearate, an olefinic thermoplastic elastomer or an amide having the chemical structure CH₃(CH₂)₇CH═CH(CH₂)ₓCONH₂ where x is selected from 5-15. In one embodiment the softening agent may be erucamide CH₃(CH₂)₇CH═CH(CH₂)₁₁CONH₂ which may also be referred to as cis-13-docosenoamide. An example of a commercially available softening agent is erucamide sold under the trademark ARMOSLIP® by Akzo Nobel having an in Chicago, Ill. Other suggested amide additives include oleylamide CH₃(CH₂)₇CH═CH(CH₂)₈CONH₂ and oleamide N-9-octadecenyl-hexadecanamide) is CH₃(CH₂)₇CH═CH(CH₂)₇CONH₂.

The softening agent is topically applied to the nonwoven at an add-on level that suitably improves the softness of the printed nonwoven material. The basis weight of the softening agent is from about 0.1 to about 6 grams per square meter, optionally from about 0.1 to about 4 grams per square meter.

The particular method of applying the softening agent to the printed surface of the nonwoven web can be any suitable treatment application method, including flexographic, gravure, offset, and ink-jet printing, slot die coating, melt spraying, solvent spray coating, thermal spray coating, meltblowing, and so forth. The application method can be used to apply the softening agent in any design, figure, or other image on the printed surface of the nonwoven web. For example, the softening agent may be placed in controlled or patterned areas on the nonwoven web, applied to the nonwoven web as a monolithic film, or applied to the nonwoven web as particulates. The softening agent can be applied neat or from a solvent system. Further the softening agent may be applied at ambient temperature or may be heated for application to the nonwoven sheet material.

Application of the softening agent to the printed surface of the nonwoven web suitably improves the softness of the printed and treated nonwoven web as measured by the static coefficient of friction test. For example, the static coefficient of friction, measured as described below, may be reduced to less than about 0.5. In other embodiments, the static coefficient of friction may be reduced to about 0.48 or less, desirably about 0.46 or less, more desirably to about 0.44 or less, or even more desirably to about 0.4 or less. In another aspect, application of the softening agent to the printed surface of the nonwoven web may reduce the static coefficient of friction by about 20 percent or more as compared to the static coefficient of friction measured of a printed nonwoven web not treated with the softening agent. In other embodiments, the application of the softening agent to the printed surface of the nonwoven web may reduce the static coefficient of friction by about 25 percent or more, desirably by about 30% or more, more desirably by about 35% or more, or even more desirably by about 40% or more as compared to the static coefficient of friction measured of a printed nonwoven web not treated with the softening agent.

Application of the softening agent to graphics on the printed surface of the sheet material or nonwoven web desirably will not impact the crockfast resistance of the printed graphics. In some embodiments, the oil Crockfastness of the printed surface treated with softening agent remains greater than about 3.0, desirably greater than about 4.0.

### Test Methods

Crockfastness: A crock test method was used to measure whether the combinations of treated nonwovens and inks had sufficient abrasion resistance. The crock test method was based upon American Association of Textile Chemists and Colorists (AATCC) Test Method 116-1983, which is incorporated herein in its entirety with a few modifications, as disclosed in international publication no WO 2004 061200A1.

The AATCC Test Method uses a device called a Rotary Vertical Crockmeter to rub a piece of test fabric against the sample specimen. This modified crock test method used a device called at Sutherland Rub Ink Tester (Sutherland 2000 Rubtester supplied by Danilee Company of San Antonio, Tex.) as an alternative to the Crockmeter. The Sutherland Rub Tester is used in the printing industry to evaluate the resistance of inks and coatings on printed substrates. It has a broader test area than the crockmeter. The test head is 2-inches×4-inches for an eight square inch test area. The test head is moved laterally over the test specimen in a shallow arc pattern. Various weights are available to alter the pressure on the test surface and the number of test “strokes” is variable. This test method used a 4.0 pound weight and 50 rub strokes at a frequency of 42 cycles per minute. The test specimen can be abraded against any material that can be readily attached to the opposing surface of the tester.

Under the AATCC method, any transfer of colorant is qualitatively rated from one to five against a standard scale. A five is equivalent to the absence of transfer and a one is equivalent to an extreme amount of colorant transfer. The primary difference between the test method used in the following examples and the AATCC method was a quantitative method of assigning a colorfastness value. The latter was achieved by using a Spectrodensiometer to assign a measurement of total colorant transfer. This measured value is known as “Delta E”. An equation was then developed to convert the Delta E value to into a one to five value equivalent to the AATCC colorfastness scale.

According to the test procedure, test specimens were analyzed for the CIELAB color difference which is expressed as E. The E was then converted to a number between 1 and 5 using the following equation: C. R.=A exp. (−B) where A=5.063244 and B=0.059532 (ΔE) if E is less than 12, or A=4.0561216 and B=0.041218(ΔE) if E is greater than 12. This number C. R. is the crockfastness rating. A rating of 1 corresponds to a low or bad result, while a rating of 5 is the highest possible test result, and this value would indicate that essentially no color was rubbed off the sample material.

With the Spectrodensitometer, greater objectivity in evaluating the results was possible due to less operator dependence, and it was also possible to achieve higher efficiency and consistency for on-line quality assurance. The X-Rite 938 Spectrodensitometer is manufactured by X-Rite, Inc., of Grandville, Mich.

### Equipment and Materials Used

1. Sutherland 2000 Rub Tester (Danilee Co., San Antonio, Tex.). Sharp edges on the vertical rod were filed to reduce abrasion of nonwoven materials.
2. Crockmeter cloth, standard 2-inch by 6-inch (approximately 50 millimeter by 152 millimeter) test squares.
3. Paper Cutter, standard 12-inch by 12 inch (305 mm×305 mm) minimum cutting area, obtained from Testing Machines, Inc., Amityville, N.Y.
4. Room with standard conditions atmosphere: temperature=23±1° C. (73.4±1.8° F.) and relative humidity=50±2 percent. Testing outside the specified limits for temperature and humidity may not yield valid results.
5. X-Rite Spectrodensitometer 938 manufactured by X-Rite, Inc., of Grandville, Michigan.

### Specimen Preparation

The test specimens were a spunbond polypropylene web and film laminate having a basis weight of about 1 ounce per square yard. The test specimens were cut exactly 2.5 inches wide by 7.0 inches long, unless otherwise noted, with the test area centered on the square.

### Testing Procedure

1. Cut samples approximately 2.5 inches wide by 7.0 inches long in the machine direction of the substrate unless otherwise noted in the special instructions.
2. Label a white 2-inch×6-inch cotton sheet with the individual sample information.
3. Place the white cotton sheet lengthwise parallel to the direction of the rub. Adhere sample to the base of the machine so that the printed surface faces up and the area to be tested is centered.
4. Weigh one piece of the crockmeter cloth. Thoroughly wet out the crockmeter cloth with baby oil, bringing the wet pickup to 65%+/−5% [% wet pickup=((weight_{wet}−weight_{dry})/weight_{dry})×100]. (When measuring the dry crockfastness, this step can be omitted. When measuring the wet crockfastness, water is substituted for baby oil.)
5. Adhere white crockmeter cloth to 4.0 pound weight by placing the sample to be tested (matching long side to long side) on the weight and taping the excess with 610 tape. Be sure that the sample is taught and the printed side of material is to be facing out when taped on to the weight.
6. Place the weight (4.0 pounds) and white cloth sample on the rub tester arm.
7. Set the rub tester for 50 rub strokes at 42 cycles per minute.
8. Start the rub tester and wait for the tester to stop.
9. Allow the tested sample to dry.
10. When the rub test for the sample is completed, staple the sample to the white cotton cloth with to a sheet of cardboard beneath the sample behind the cloth.
11. Once the rub testing for a batch of samples is completed Spectrodensiometer reading may begin. However, samples that were tested with water or oil must be allowed to dry in an open area of 24 hours before spectrodensiometer testing.
12. Be sure that the illuminate is set to C²
13. Calibrate the spectrodensiometer on the white spot using the tile provided.
14. Be sure that the data mode for the printout is set to Difference mode and that it is D50/10 and Lab.
15. A white standard must be read in each new day of Spectrodensiometer reading or more frequently if noted in special instructions. This is done by piling 7 cotton cloths on top of each other and setting the reference with this.
16. Read each sample, reading the area that appears to have the most amount of ink transfer, beginning with the white standard if necessary then proceeding through the batch.
17. Number the sample during the reading consecutively from 1 to the end with number 1 being the white standard if necessary. These numbers should match the printout.
18. After reading all of the samples with the Spectrodensiometer, print out the report and label the report with sample information. (i.e. White standard and Sample identity.)

### Optional Wet Sample Testing:

1. Weigh the Crockmeter cloth standard. Record the weight.
2. Thoroughly wet out the material with the appropriate solution,
3. Bring the wet pick-up to 65+/−0.5 percent (This is done by wringing or blotting the excess solution from the material, weighing the material and calculating the percent pick-up. Calculate: wet weight minus dry weight divided by dry weight times 100=percent pick-up). To prevent evaporation, prepare one wet cloth at a time for testing.
4. Proceed with Steps 4 through 18.

### Evaluation

The next step is the second modification to the AATCC test procedure, as earlier described above. The second modification is that the amount of color transferred to the test specimen was measured using an X-Rite Spectrodensitometer, instead of the AATCC Chromatic Transference Scale or a grade scale measuring device. As earlier described, E is then obtained and converted to a crockfastness rating between 1 and 5 using the equation set forth above.

Each specific sample was tested multiple times to obtain an average reading. The average was determined by individually calculating the crockfastness rating for each of the test specimens, summing the crockfastness ratings, and then dividing by the number of samples to get the average crockfastness rating.

Coefficient of Friction: Coefficient of Friction testing was done in accordance with ASTM D 1894-78 using a high gloss smooth vinyl tile sliding surface.

### EXAMPLES

Printed adhesively-bonded spunbond/film laminates (aSFL) and thermally-bonded breathable stretch-thinned spunbond/film laminates (bSTL), substrates, were coated with erucamide by spraying molten erucamide on to the substrates with heated air. The erucamide used was from Akzo Nobel with the brand name Armoslip-E. Different add-on levels were obtained by running the substrates at different speeds. Add-on levels were determined by determining differences in weight measurements of the coated and uncoated substrates. For aSFL printed with acrylic-based inks available from Polytex Environmental Inks containing crosslinlcer PENTAERYTHRITOL-TRIS-(B-(AZIRDINYL)PROPIONATE) (XAMA 7, produced by Noveon), add-on levels from 1.3 gsm to 5.8 gsm were obtained. On the bSTL with graphics created with Arrowflex inks available from Flint, add-on levels from 2.6 gsm to 10 gsm were obtained. The two substrates had different widths, resulting in different add-on levels.

Crockfastness (CR) was measured on the substrates, as described above, to determine the impact of erucamide on rub resistance. The results are shown in Table 1.

TABLE 1
Crockfastness

| | Add-on | Crockfastness data | | | | | |
|---|---|---|---|---|---|---|---|
| Sample/ | level | CR | Stdev. | CR | Stdev. | CR | Stdev. |
| linespeed | g/m² | Dry | Dry | Wet | Oil | Oil | Oil |

Substrate: aSFL printed as described above

| | | | | | | | |
|---|---|---|---|---|---|---|---|
| Control | 0.0 | 4.78 | 0.04 | 4.77 | 0 | 4.47 | 0.11 |
| 120 ft/min | 1.3 | 4.8 | 0.01 | 4.83 | 0.02 | 4.58 | 0.02 |
| 90 ft/min | 1.6 | 4.78 | 0.06 | 4.84 | 0.04 | 4.53 | 0.09 |
| 60 ft/mi | 2.7 | 4.78 | 0.02 | 4.87 | 0.02 | 4.5 | 0.09 |
| 45 ft/min | 3.7 | 4.76 | 0.09 | 4.87 | 0.03 | 4.42 | 0.03 |
| 30 ft/min | 5.8 | 4.8 | 0.04 | 4.82 | 0.02 | 4.61 | 0.02 |

Substrate: bSTL printed as described above

| | | | | | | | |
|---|---|---|---|---|---|---|---|
| Control | 0 | 4.53 | 0.08 | 4.47 | 0.1 | 2.54 | 0.12 |
| 120 ft/min | 2.6 | 4.44 | 0.29 | 4.77 | 0.1 | 2.81 | 0.27 |
| 90 ft/min | 3.6 | 4.78 | 0.06 | 4.85 | 0.07 | 2.89 | 0.22 |
| 60 ft/mi | 6.0 | 4.66 | 0.15 | 4.76 | 0.15 | 2.68 | 0.19 |
| 45 ft/min | 8.2 | 4.74 | 0.04 | 4.75 | 0.2 | 2.47 | 0.09 |
| 30 ft/min | 10.1 | 4.6 | 0.08 | 4.77 | 0.08 | 2.56 | 0.29 |

The results show that erucamide spray coating has minimal or no negative impact on crockfastness of the printed bSTL or aSFL. There is even a directional improvement in wet rub resistance (Crockfastness).

Erucamide (Armoslip-E) was coated at various add-on levels onto printed aSFL material (printed 12 gsm spunbond polypropylene (SFT-315 polypropylene available from Exxon-Mobil Chemical Company) fibers laminated with 1 gam Rextac 2215 adhesive (available from Huntsman Polymers of Houston, Tex.) to a breathable 17 gsm LLDPE stretch-thinned film containing 60% CaCO₃ with 1 micron average particle size) by a slot coating process four hours after printing, Crockfastness (CR) was measured on the substrates, as described above, to determine the impact of erucamide on rub resistance. The results are shown in Table 2. Softness was evaluated by measuring Coefficient of Friction as described above. The results are shown in Table 3.

TABLE 2
Crockfastness

| | CR | Dry | CR | Wet | CR | Oil |
|---|---|---|---|---|---|---|
| Add-on level, g/m2 | Dry | stdev | Wet | Stdev | Oil | Stdev |
| Control - 0 gsm | 4.87 | 0.03 | 4.83 | 0.05 | 3.56 | 0.08 |
| 1 gsm | 4.83 | 0.03 | 4.92 | 0.03 | 3.44 | 0.24 |
| 2 gsm | 4.86 | 0.03 | 4.91 | 0.01 | 3.56 | 0.11 |
| 3 gsm | 4.84 | 0.03 | 4.95 | 0.02 | 3.99 | 0.08 |
| 4 gsm | 4.92 | 0.03 | 4.91 | 0.03 | 3.96 | 0.02 |

TABLE 3
Softness

| | Coefficient of Friction (COF) | | | | | |
|---|---|---|---|---|---|---|
| | Peak Load | | | | Dynamic (kinetic) | |
| | (gf) | | Static COF | | COF | |
| Add-on | | std | | std | | std |
| level, g/m2 | average | dev | average | dev | average | dev |
| Control - 0 gsm | 147 | 21 | 0.74 | 0.11 | 0.33 | 0.03 |
| 1 gsm | 100 | 18 | 0.51 | 0.09 | 0.34 | 0.06 |
| 2 gsm | 99 | 12 | 0.50 | 0.06 | 0.30 | 0.03 |
| 3 gsm | 92 | 4 | 0.46 | 0.02 | 0.31 | 0.03 |
| 4 gsm | 88 | 10 | 0.44 | 0.05 | 0.32 | 0.03 |

Erucamide was coated at various add-on levels onto printed aSFL material as described above by a slot coating process after printing. Crockfastness (CR) was measured on the substrates, as described above, to determine the impact of erucamide on rub resistance. The results are shown in Table 4. Softness was evaluated by measuring Coefficient of Friction (gf) as described above. The results are shown in Table 5.

TABLE 4
Crockfastness

| | Dry | Dry | Wet | Wet | Oil | Oil |
|---|---|---|---|---|---|---|
| Add-on level | CR | Stdev | CR | Stdev | CR | Stdev |
| Control - 0 gsm | 4.87 | 0.02 | 4.84 | 0.02 | 4.27 | 0.08 |
| 2 gsm | 4.97 | 0.05 | 4.92 | 0.01 | 4.14 | 0.06 |
| 6 gsm- | 4.96 | 0.00 | 4.97 | 0.02 | 4.44 | 0.13 |
| 8 gsm- | 4.94 | 0.01 | 4.94 | 0.04 | 4.24 | 0.07 |
| 10 gsm- | 4.94 | 0.04 | 4.97 | 0.04 | 4.54 | 0.10 |

TABLE 5
Softness

| | Coefficient of Friction (gf) | | |
|---|---|---|---|
| Add-on level, g/m² | Peak Load | Static COF | Dynamic (kinetic) COF |
| 0 gsm | 86.9 | 0.44 | 0.21 |
| 2 gsm | 80.2 | 0.41 | 0.31 |
| 4 gsm | 79.8 | 0.40 | 0.30 |
| 6 gsm | 72.9 | 0.37 | 0.25 |
| 8 gsm | 73.9 | 0.37 | 0.22 |
| 10 gsm | 70.1 | 0.35 | 0.21 |

As can be seen in the Tables, Crockfastness generally increased (improved) and Static Coefficient of Friction generally decreased (improved) as the amount of softening agent (erucamide) that was applied over the printed graphic was increased.

These and other modifications and variations to the present invention may be practiced by those of ordinary skill in the art, without departing from the spirit and scope of the present invention, which is more particularly set forth in the appended claims. In addition, it should be understood the aspects of the various embodiments may be interchanged either in whole or in part. Furthermore, those of ordinary skill in the art will appreciate that the foregoing description is by way of example only, and is not intended to limit the invention so further described in the appended claims.

1. An article defining a visible surface comprising:
a sheet material,
an ink composition overlaying the sheet material, and,
a softening agent overlaying the ink composition, wherein the ink composition is positioned between the sheet material and the softening agent.

2. An article as in claim 1, wherein the sheet material comprises synthetic polymer fibers interlaid to form a nonwoven web.

3. An article as in claim 1, wherein the softening agent is selected from the group consisting of erucamide, cetyl 2-ethylhexanone, ethylhexyl stearate, ethylhexyl hydroxyetarate, and perfluorinated dimethicone.

4. An article as in claim 1, wherein the basis weight of the softening agent is from about 0.1 to about 6 grams per square meter, optionally from about 0.1 to about 4 grams per square meter.

5. An article as in claim 1, wherein the basis weight of the ink composition is from about 0.01 to about 10 grams per square meter, optionally from about 0.01 to about 2 grams per square meter.

6. An article as in claim 1, wherein the basis weight of the sheet material is from about 6 to about 50 grams per square meter.

7. An article as in claim 1, wherein the ink composition comprises a crosslinking agent in an amount of greater than about 3.5% by weight based on the dried weight of the ink composition, wherein the crosslinking agent comprises an aziridine oligomer with at least two aziridine functional groups.

8. An article as in claim 2, wherein the nonwoven web comprises polyolefin fibers.

9. An article as in claim 1, wherein the ink composition further comprises an acrylic colloidal dispersion polymer.

10. An article as in claim 1, wherein the web has an oil crockfastness of greater than about 3.0, optionally greater than about 4.0, and a static coefficient of friction about 0.5 or less.

11. An article as in claim 2, wherein the nonwoven web is laminated to a breathable film comprising micropores such that the visible surface of the nonwoven web is opposite of the breathable film.

12. An absorbent article comprising:
a liquid permeable topsheet;
an absorbent core; and
a liquid impermeable backsheet, wherein the absorbent core is positioned between the topsheet and the backsheet, the backsheet comprising a nonwoven web overlying a film layer such that the film layer faces the absorbent core and the nonwoven web defines a visible surface comprising synthetic polymer fibers interlaid to form a nonwoven web, an ink composition overlaying the synthetic polymer fibers of the nonwoven web, and, a softening agent overlying the ink composition, wherein the ink composition is positioned between the synthetic polymer fibers and the softening agent.

13. An absorbent article as in claim 12, wherein the softening agent is selected from the group consisting of erucamide, cetyl 2-ethylhexanone, ethylhexyl stearate, ethylhexyl hydroxyetarate, and perfluorinated dimethicone.

14. An absorbent article as in claim 12, wherein the basis weight of the softening agent is from about 0.1 to about 6 grams per square meter, optionally from about 0.1 to about 4 grams per square meter.

15. A method of providing a soft, printed nonwoven web, the method comprising:
providing a nonwoven web of synthetic fibers, wherein the nonwoven web has a visible surface, and
applying an ink composition to the visible surface of the nonwoven web to form a printed surface,
applying a softening agent to the printed surface.

16. A method as in claim 15, wherein the softening agent is selected from the group consisting of erucamide, cetyl 2-ethylhexanone, ethylhexyl stearate, ethylhexyl hydroxyetarate, and perfluorinated dimethicone.

17. A method as in claim 15, wherein the softening agent is flexographically printed on the nonwoven web.

18. A method as in claim 15, wherein the softening agent is ink jet printed on the nonwoven web.

19. A method as in claim 15, wherein the softening agent is slot coated on to the nonwoven web, solvent spray coated on to the nonwoven web, thermal spray coated on to the nonwoven web, meltblown on to the nonwoven web, placed in controlled or patterned areas on the nonwoven web, or applied to the nonwoven web as a monolithic film or particulates.

20. A method as in claim 15, wherein the ink composition comprises a crosslinking agent in an amount of greater than about 1.0% by weight, optionally greater than about 3.5% by weight, based on the dried weight of the ink composition, wherein the crosslinking agent comprises an aziridine oligomer with at least two aziridine functional groups, and further wherein the method further comprises the step of crosslinking the ink composition after applying the softening agent.
